(19) United States
(12) Patent Application Publication
(10) Pub. No.: US 2026/0240705 A1
(43) Pub. Date: Aug. 20, 2026

(54) LEG SUPPORTING AID AND METHOD FOR PRODUCING THE SAME

(71) Applicant: Innovative Orthopedic Technologies IOT AG, Buchs (CH)

(72) Inventors: Luigi Bivi, Zurich (CH); Manfred Menzi, Zurich (CH); Léo Roux, Caluire-et-Cuire (FR)

(73) Assignee: Innovative Orthopedic Technologies IOT AG, Buchs (CH)

(21) Appl. No.: 19/160,922

(22) PCT Filed: Feb. 29, 2024
(86) PCT No.: PCT/EP2024/055273

§ 371 Date: Aug. 29, 2025

(30) Foreign Application Priority Data
Mar. 6, 2023 (DE) 10 2023 105 491.0
Mar. 6, 2023 (DE) 20 2023 101 055.5

(51) Int. Cl. A61G 13/12

(52) U.S. Cl. CPC A61G 13/1245; A61G 13/125

(57) ABSTRACT

A leg supporting aid comprises a main body having a longitudinal direction (L) and a transverse direction (Q) in plan view. The longitudinal direction has a greater extent than the transverse direction. The main body has at least three placement regions (10, 11, 12, 13, 14) and at least two support regions (20, 21, 22, 23). In the longitudinal direction of the main body each of the support regions is respectively located between two placement regions connected to one another via the respective support region. The placement regions are coplanar. The support regions have different heights relative to the adjacent placement regions. Furthermore, the placement regions and support regions are manufactured in one piece and thus constitute the main body.

### CROSS-REFERENCE TO RELATED APPLICATIONS

This application is a 371 of international application no. PCT/EP2024/055273, filed Feb. 29, 2024 and titled LEG SUPPORTING AID AND METHOD FOR PRODUCING SAME, which claims the benefit of German Application No. 10 2023 105 491.0, filed Mar. 6, 2023 and titled LEG POSITIONING AID AND METHOD FOR PRODUCING THE SAME, and claims the benefit of German Application No. 20 2023 101 055.5, filed Mar. 6, 2023 and titled LEG POSITIONING AID.

### TECHNICAL FIELD

The present invention relates to a leg supporting aid and a method for producing the same.

### BACKGROUND

Leg supporting aids are used in surgical orthopedics/surgery in order to support a leg of a patient in an extended or fully or partially angled manner as required, for example in the context of a knee surgery. For this purpose, the leg supporting aid is temporarily fastened on an operating table or a leg support of an operating table. This fastening is generally effected by means of straps with a quick-release fastener (for example hook-and-loop fastener). Such a leg supporting aid is often combined with a separate lateral support for the thigh and/or lower leg of a patient, which is part of the prior art and therefore is not described in greater detail here.

For example, from the international design registration DM/206 429 a leg supporting aid consisting of a flat plate on which four gate-shaped support elements are arranged is already known. The gate-shaped support elements have different heights and are arranged spaced apart parallel to one another transversely to a longitudinal extent of the plate in such a way that the height of the gate-shaped support elements increases from a lowest gate-shaped support element to a highest gate-shaped support element.

### SUMMARY

The present document evolves the leg supporting aid already known from the international design registration DM/206 429 with regard to its sterilizability, producibility, strength and X-ray signature.

The above is achieved by a leg supporting aid with the combination of the features of claim 1 and a method for producing a leg supporting aid with the combination of the features of claim 16. Preferred developments are found in the dependent claims.

Embodiments of a leg supporting aid comprise an in particular rigid main body having (in plan view of the main body) a longitudinal direction and a transverse direction. The longitudinal direction has a greater extent than the transverse direction. The main body has at least three placement regions along its longitudinal direction, with which the main body can be placed on an (in particular planar) surface supporting the main body. Furthermore, the main body has at least two support regions along its longitudinal direction, which are configured to support a lower leg or the sole of a patient's foot. In the longitudinal direction of the main body, the support regions are respectively located between two placement regions connected to one another via the respective support region, whereby adjacent placement regions are spaced apart from one another by a support region located therebetween. The placement regions of the main body are coplanar, i.e. they lie in one plane, and are spaced apart from one another in this plane. It is permissible that edge regions of the placement regions are not coplanar but are rounded or even pulled slightly upward in order to facilitate sliding of the placement regions on a planar surface supporting the base support (such as for example the upper side of an operating table). The support regions have different heights relative to the adjacent placement regions. Depending on whether all support regions are used jointly to support a lower leg of a patient, or whether one of the support regions (possibly in cooperation with an adjacent support region) is used to support the sole of a patient's foot, the leg of the patient can be stably supported either being straight or angled at the knee joint. According to the invention, the placement regions and support regions are jointly manufactured in one piece and thus constitute the main body.

The one-piece construction of the placement regions and support regions avoids, in comparison to gate-shaped support elements mounted on a plate, gaps between the support elements and the plate, which can only be cleaned and disinfected with difficulty. Furthermore, production is facilitated since it is not necessary to mount separate support elements on a base plate. The durability of the leg supporting aid is also increased since, as a result of the one-piece construction, there is no risk of the support regions becoming detached from the placement regions. Finally, as a result of the one-piece construction of placement regions and support regions, the ability of the leg supporting aid to be penetrated by X-rays is also improved since, due to the use of the same material, the placement regions and support regions have the same effect on (i.e., absorption of) X-rays.

According to an embodiment, the material thickness/thickness of the main body in the placement regions deviates from the material thickness/thickness of the main body in the support regions by less than 20% and preferably by less than 10% and more preferably by less than 5%, whereby the main body has a substantially constant material thickness/thickness. This substantially constant material thickness/thickness further improves the ability of the leg supporting aid to be uniformly penetrated by X-rays.

According to an embodiment, both in the longitudinal direction and in the transverse direction of the main body the material thickness of the main body varies in a direction which is perpendicular to a plane defined by the placement regions by less than 20% and preferably by less than 10% and more preferably by less than 5% and is in particular constant. According to an embodiment, both in the longitudinal direction and in the transverse direction of the main body the material thickness of the main body in a direction which is perpendicular to a plane defined by the placement regions in the support regions amounts to between one and seven times or between one and five times the material thickness of the main body in the placement regions. Since X-ray images are usually produced along this direction, this leads to an ability of the leg supporting aid of being particularly uniformly penetrated by X-rays.

According to an embodiment, the support regions have a U-shaped or V-shaped cross-section in the longitudinal direction of the main body, wherein the free ends of the legs of the “U” or “V” of each support region merge via radii into the placement regions adjacent to the support region. This cross-section facilitates the producibility of the leg supporting aid since the main body can thus be formed by means of a simple casting mold or by plastic deformation of a plate-shaped main body by means of punches. Alternatively, due to the use of the same material in the placement regions and support regions, production by 3D printing is also possible. Furthermore, this cross-section leads to good support of the support regions on the adjacent placement regions and consequently to high stability of the leg supporting aid.

According to an embodiment, the support regions have a support body at the junction of the legs of the “U” or “V” (and thus at the ends of the support regions which face away from the placement regions), the material of which support body differs from the material of the main body. This allows the main body to be optimized with regard to its strength and the support bodies to be optimized with regard to contact with the patient. These support bodies can be produced, for example, by casting; alternatively, for example, production of the support bodies by cutting or 3D printing is also possible.

According to an embodiment, the main body can then consist of hard plastics material such as, for example, duromer or plastomer and in particular of injection-moulded polycarbonate or polyester, and the support bodies can consist of soft plastics material such as, for example, rubber or foam material and in particular of closed-cell foam material or integral foam (that is to say foam material with a solid outer skin). The foam material can be, for example, polyurethane or ethylene-propylene-diene rubber. During production by 3D printing, for example, a light-curing resin can be used for the main body. The main body can finally (in particular in case of production by 3D printing) be subjected to a surface treatment with resin or lacquer in order to increase the surface quality.

According to an embodiment, the support bodies can be non-detachably connected to the respectively associated support region by injection-molding or adhesive bonding or a snap-on connection. In this case, connections are preferred which lead to no or only slight gap formation in order to facilitate the cleaning and disinfection of the leg supporting aid. According to an alternative embodiment, the support bodies can also be detachably connected to the respectively associated support region by a screw connection or snap-on connection; as a result, it is possible to adapt the support bodies if necessary or replace them in case of wear.

According to an embodiment, the material used for the support bodies behaves like the material used for the main body with regard to penetration by X-rays. Preferably, the material used for the support bodies and/or the material used for the main body is transparent to X-rays (within the scope of what is technically possible) (for example the material is largely free of heavy atoms beyond Cl).

According to an embodiment, in the transverse direction of the main body the support bodies extend in a straight line. Furthermore, the support bodies have projections at their ends in the transverse direction of the main body, which projections are oriented away from the placement regions of the main body. These projections prevent a lower leg or a sole of a patient's foot from being able to slip unintentionally laterally from the support body and thus from the support region. According to an embodiment, surfaces of the support bodies are rounded. According to an embodiment, some support bodies have recesses in a central section. These recesses can receive, for example, the Achilles tendon of a patient and thus increase the supporting comfort. According to an embodiment, in a state mounted on a respectively associated support region the support bodies have a flat surface on a side which faces support regions having a smaller height than the support region on which the respective support body is mounted, and the support bodies have a rounded and in particular cylindrical surface on a side facing away from the flat surface. According to an embodiment, the flat surfaces of the support bodies enclose an angle of between 35° and 55° and in particular of between 40° and 50° and more particularly an angle of 45°with a plane defined by the placement regions in the mounted state of the support bodies.

These flat surfaces of the support bodies allow the reliable and planar support of the sole of a patient's foot, whereas the rounded surfaces allow the comfortable support of the lower leg of a patient.

According to an embodiment, on their side facing away from the placement regions, the support bodies have a surface in a state mounted on a respectively associated support region, which surface defines a radius of curvature of between 1 m and 2 m and in particular of 1.5 m in the transverse direction of the leg supporting aid.

This curvature of the surface allows self-centering and even more comfortable placement of the lower leg of a patient.

According to an embodiment, in a state of the support bodies mounted on a respectively associated support region, on a side which faces away from support regions having a smaller height than the support region on which the respective support body is mounted, the support bodies have weakenings and in particular air ducts extending in the transverse direction of the leg supporting aid in the interior of the support bodies.

These air ducts allow the hardness of the support bodies to be adjusted locally. In regions in which many air ducts are present, the support body is comparatively soft. This is recommended for regions of the support bodies which are intended to support the lower leg of a patient. In regions in which little or no air ducts are present at all, the support body is comparatively hard.

This is recommended for regions of the support bodies which are intended to support the sole of a patient's foot.

According to an embodiment, in plan view the main body has the shape of a ladder. In this case, with the exception of the lowermost and uppermost rungs that are formed by placement regions, rungs of the ladder are formed by the support regions. As a result, the main body is defined in the transverse direction on the one hand on the plane of the placement regions and on the other hand on the plane of the ends of the support regions facing away from the placement regions, which leads to high stability of the main body. However, it is emphasized that it is not harmful to provide one or more additional rungs which are formed by placement regions between the lowermost and uppermost rungs of the ladder. Beams of the ladder are formed jointly by sections of the placement regions and the support regions. The beams of the ladder do not project beyond the lowermost and uppermost rungs.

According to an embodiment, elongated holes for receiving a fastening strap are formed in placement regions that are spaced apart from one another by at least one support region. This fastening strap can have a quick-release fastener (for example in the form of a hook-and-loop fastener) and allows the leg supporting aid to be temporarily fastened on an operating table or a leg support of an operating table.

According to an embodiment, in a direction which is perpendicular to a plane defined by the placement regions the support regions of the main body have a greater extent in relation to this plane than the placement regions.

According to an embodiment, the main body has at least four placement regions and at least three support regions or at least five placement regions and at least four support regions or at least six placement regions and at least five support regions. It has been found that a greater number of support regions does not lead to any substantial improvement of the leg supporting aid since such a precise adjustment of the setting angle of a leg is not necessary. At the same time, fewer than three support regions allow only a very coarse adjustment of the setting angle of a leg.

According to an embodiment, a height of the support regions relative to the adjacent placement regions is between 1.5 cm and 20 cm and in particular between 2 cm and 15 cm.

According to an embodiment, a material thickness of the main body is between 4 mm and 15 mm and in particular between 8 mm and 12 mm and more particularly amounts to 10 mm.

According to an embodiment, in the longitudinal direction of the main body the support regions are arranged such that their height relative to the adjacent placement regions increases from one end of the main body to the other end of the main body.

According to an embodiment, in the longitudinal direction of the main body the support regions are arranged such that their free ends (their ends facing away from the adjacent placement regions) jointly define a plane which encloses an angle with a plane defined by the placement regions of between 5° and 15° and in particular of between 8° and 14° and more particularly of approximately 9.8° or 11.8°. When determining this angle, it is sufficient if the plane is common to two support regions so that other support regions can be left out of consideration.

According to an embodiment, the main body has five placement regions and four support regions, wherein the height of the support regions relative to the respectively adjacent placement regions is 4.1 cm, 6.7 cm, 9.2 cm and 13.4 cm if the additional contribution of the support bodies used to the height is 4.1 cm, and wherein perpendicular bisectors of adjacent support regions are each spaced apart by 15 cm. The height difference of adjacent support regions is thus between 2 cm and 5 cm and in particular 2.6 cm, 2.5 cm and 4.2 cm.

According to an embodiment, at least the lowest support region of the support regions relative to the adjacent placement regions has a recess as seen in the longitudinal direction of the main body, which recess is limited in the height direction (the direction perpendicular to the plane defined by the placement regions) on its side facing away from the placement regions by the support body associated with the support region. Since the lowest support region faces the patient when using the leg supporting aid, the recess allows the foot of a patient to be accommodated until the back of the foot comes into contact with the support body. In this way, the leg of a patient can be fixed in a strongly angled position. At the same time, damage to the sensitive back of the foot is avoided since it does not come into contact with the comparatively hard main body but rather with the comparatively soft support body. In addition, the hardness of the support body can be selected independently of the hardness of the main body.

According to an embodiment, the recess then has a free cross-section as seen in the longitudinal direction of the main body, which is able to accommodate a rectangle with a width (in the transverse direction of the main body) of more than 8 cm and in particular with a width of between 9 cm and 11 cm and further in particular with a width of 10 cm and a height (perpendicular to the transverse direction of the main body) of between 2 cm and 5 cm and in particular a height of 4 cm.

Embodiments of a method for producing the above-described leg supporting aid comprise the following steps:
producing a main body as described above by injection molding, plastic deformation or 3D printing and attaching support bodies to the regions of the support regions of the main body which face away from the adjacent placement regions, wherein the support bodies are formed from a material different from the main body.

### BRIEF DESCRIPTION OF THE DRAWINGS

Embodiments of the invention are explained in more detail below with reference to figures. In the figures:

FIG. 1 shows a perspective view of a leg supporting aid according to an embodiment;

FIG. 2 shows a schematic plan view of the leg supporting aid of FIG. 1;

FIG. 3 shows a side view of the leg supporting aid of FIG. 1;

FIG. 4a shows a view from the front of the leg supporting aid of FIG. 1;

FIG. 4b shows a view from the rear of the leg supporting aid of FIG. 1;

FIG. 5a shows a perspective view of the front side of a support body;

FIG. 5b shows a perspective view of the rear side of the support body;

FIG. 5c shows a view from the front of the support body; and

FIGS. 6a to 6f schematically show the use of the leg supporting aid viewed from the side.

### DETAILED DESCRIPTION

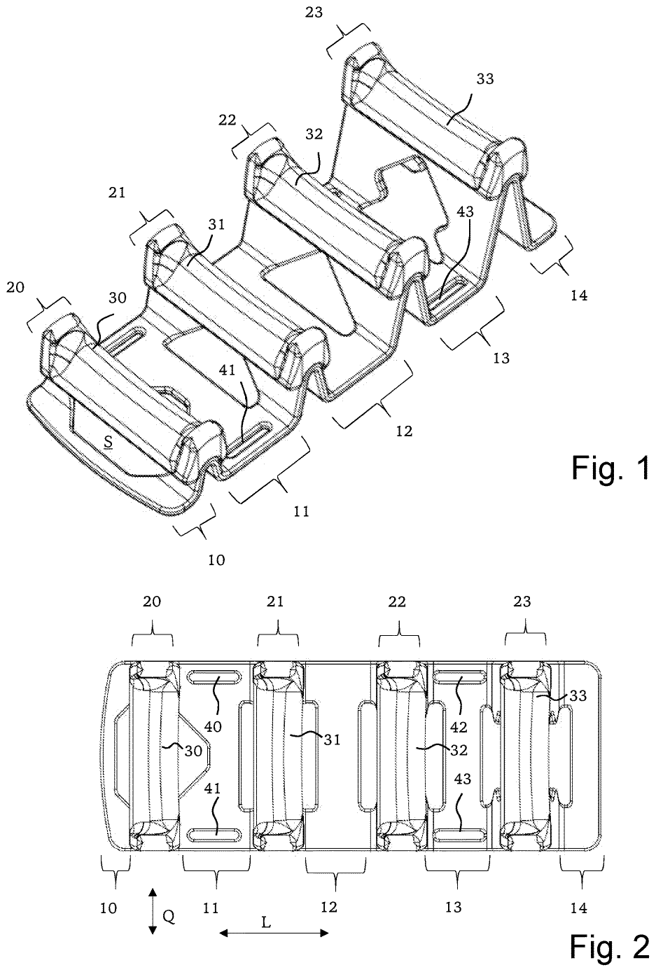

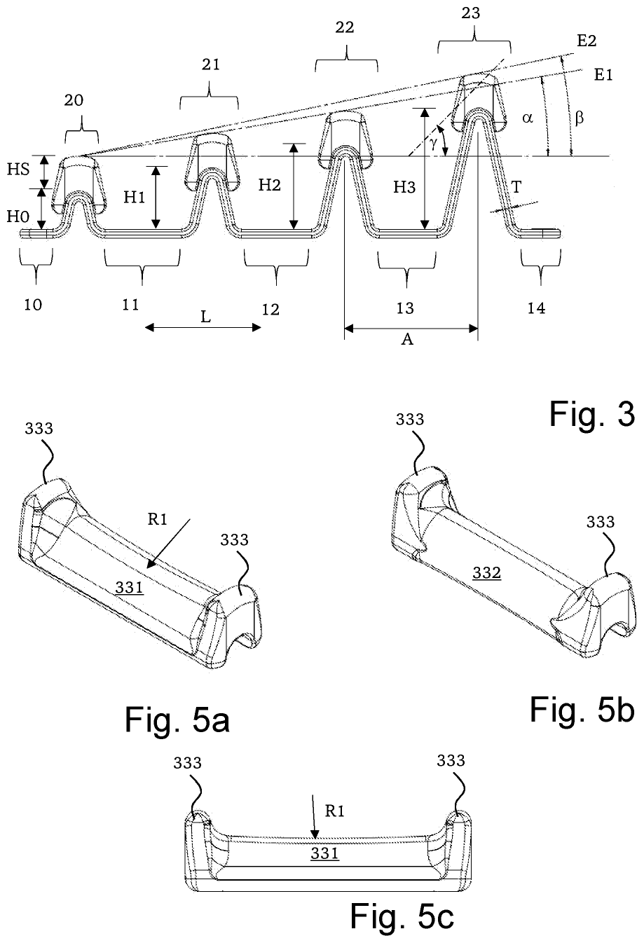

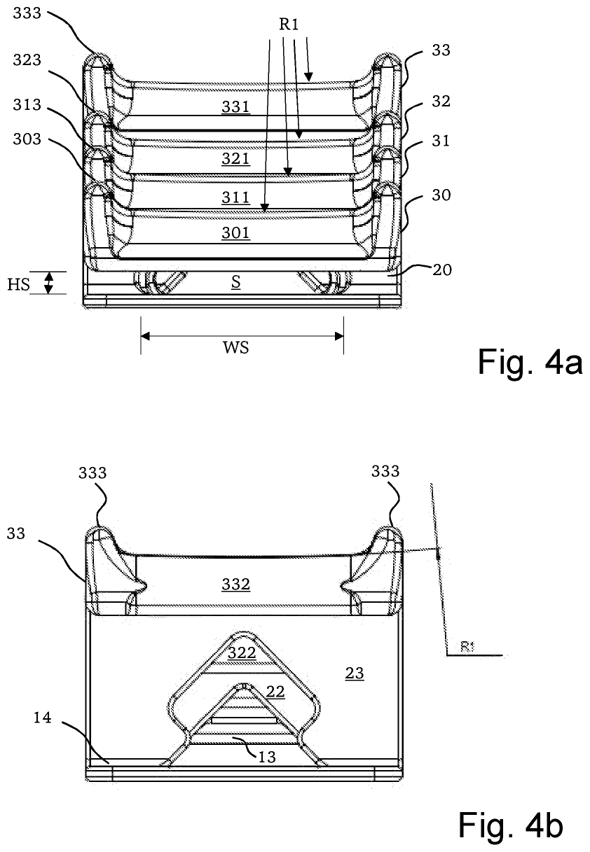

An embodiment of a leg supporting aid is described below with reference to the figures. FIG. 1 is a perspective view of the leg supporting aid, and FIG. 2 is a schematic plan view, FIG. 3 is a side view, FIG. 4a is a view from the front and FIG. 4b is a view from the rear of the leg supporting aid of FIG. 1. The view from the front is the view which faces a patient when using the leg supporting aid.

The leg supporting aid according to the embodiment comprises a main body of light-curing resin having a greater extent in the longitudinal direction L than in the transverse direction Q.

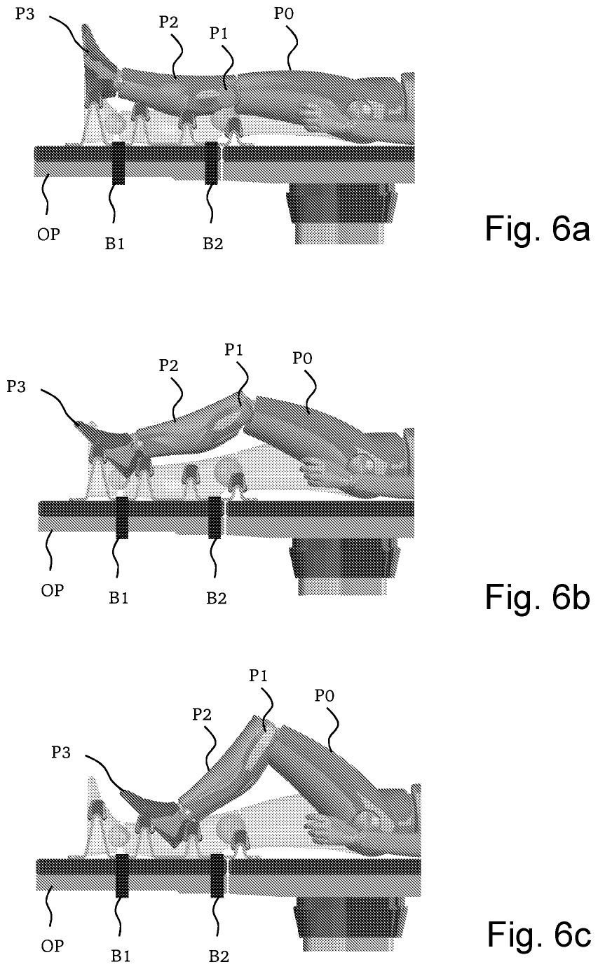

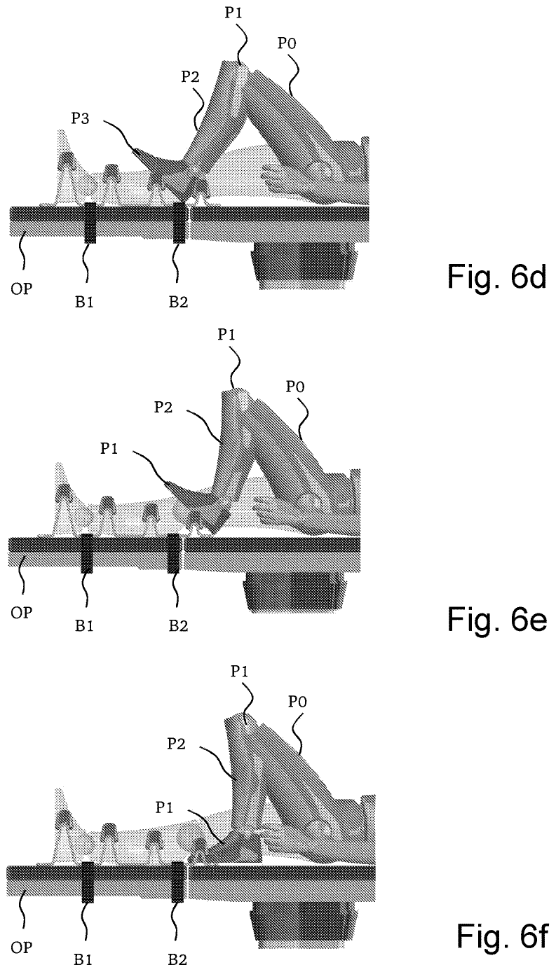

As can be clearly seen from a combined view of FIGS. 1 to 3, 4a and 4b, the main body has five coplanar placement regions 10, 11, 12, 13, 14, with which the leg supporting aid can be placed on a surface such as for example an operating table shown in FIGS. 6a to 6f. Between two placement regions 10 and 11, 11 and 12, 12 and 13 and 13 and 14 that are adjacent in the longitudinal direction of the main body, a support region 20, 21, 22, 23 is respectively provided which is manufactured in one piece with the adjacent placement regions 10 and 11, 11 and 12, 12 and 13 and 13 and 14. The support regions 20, 21, 22, 23 have an end (the “tip” of the support regions) which is spaced apart from the adjacent placement regions 10 and 11, 11 and 12, 12 and 13 and 13 and 14 and which defines a height H0 of 4.1 cm, H1 of 6.7 cm, H2 of 9.2 cm and H3 of 13.4 cm of the respective support region 20, 21, 22, 23 (the height is relative to the surface of the placement regions). Support bodies 30, 31, 32, 33 are provided at ends of the support regions 20, 21, 22, 23 that are spaced apart from the adjacent placement regions 10 and 11, 11 and 12, 12 and 13 and 13 and 14. These support bodies 30, 31, 32, 33 are explained in more detail below. The support bodies 30, 31, 32, 33 increase the height of the support regions 20, 21, 22, 23 in each case by a height HS of 4.1 cm. The perpendicular bisectors of adjacent support regions 20, 21, 22, 23 are spaced apart from one another in the longitudinal direction L of the main body by a constant distance A of 15 cm. At this distance, the foot of an average patient lies well on the respective support body with the knee being bent and being at the same time supported by the support body of an adjacent support region. The material thickness/thickness T of the main body is the same in the placement regions 10, 11, 12, 13, 14 and the support regions 20, 21, 22, 23 and amounts to 1.0 cm. The above dimensions can be reduced for particularly small patients and increased for particularly large patients. The material thickness/thickness T of the main body depends substantially on the material used.

In the embodiment shown, the support regions 20, 21, 22, 23 are arranged such that their height H0, H1, H2, and H3 increases or decreases in the longitudinal direction L of the main body. The ends of the support regions 20, 21 and 22 that are spaced apart from the adjacent placement regions 10 and 11, 11 and 12, and also 12 and 13 define a plane E1 which encloses an angle α of 9.8° with a plane defined by the placement regions 10, 11, 12, 13, 14. The two outermost support regions 20 and 23 define a plane E2 which encloses an angle β of 11.8° with a plane defined by the placement regions 10, 11, 12, 13, 14.

In the embodiment shown, the height difference between adjacent support regions in the support regions 20, 21 and 22 is approximately constant and amounts to around 2.5 cm. In contrast, the height difference between the two highest support regions 22 and 23 is significantly increased (almost doubled) and amounts to 4.2 cm. In this way, it is achieved that the knee of a patient when the leg is straight through approaches the height at which the knee is located in the case of an angled leg. This improves the ergonomics for a surgeon. Reference is made to FIGS. 6a to 6f.

As shown schematically in FIGS. 6a to 6f, the ends of the support regions 20, 21, 22, 23 serve to support the sole of a foot P3 of a patient or the lower leg P2 of the patient via the respective support bodies 30, 31, 32, 33. Depending on which of the support regions 20, 21, 22, 23 is used, this leads to the fact that a different angle of between approximately 180° and approximately 30° can be set between the thigh P0 and the lower leg P2 in the region of a knee joint P1. FIGS. 6a to 6f also show the operating table OP, to which the leg supporting aid is detachably fastened by means of fastening straps B1, B2, which are directed through the elongated holes 40, 41, 42 and 43. FIGS. 6a to 6f do not show an operating cloth which covers the leg supporting aid during an operation and is thus arranged between the leg supporting aid and the leg or foot of a patient.

In the position shown in FIG. 6f, the leg is angled to such an extent that the calf of the lower leg P2 comes into contact with the thigh P0. This is also referred to as hyperflexion and leads to prestressing of the knee joint P1 away from the thigh P0. In order to fix the leg in this position, the foot P1 of the patient is fixed by the lowest support region 20. As can be seen in FIG. 4a, the lowest support region 20 has a recess S for this purpose, into which the foot P1 of the patient is inserted until the back of the foot bears against the underside of the support body 30. For this purpose, in the embodiment shown the recess S has a width WS of 10 cm and a height HS of 3 cm and the shape of a rounded rectangle. However, the dimensions of the recess S are not limited to these values. It is sufficient if the recess S is shaped in such a way that it can at least partially receive the foot P1 of the patient. It is important that the recess S is limited upwards (away from the plane defined by the placement regions) by the comparatively soft support body 30 so that the back of the foot of the patient does not bear against the comparatively hard material of the main body and is injured.

As can be seen from a combined view of FIGS. 1, 2, 4a and 4b, the remaining support regions 21, 22 and 23 also have recesses. However, these serve primarily to save material and/or aesthetic reasons.

Due to the approximately V-shaped cross-section of the support regions 20, 21, 22, 23 in FIGS. 3 and 6a to 6f, these can easily dissipate a force exerted by the leg of the patient to the adjacent placement regions 10, 11, 12, 13 and 14.

In order to prevent the foot P3 or lower leg P2 of the patient from slipping laterally from the support regions 20, 21, 22, 23 and to increase the comfort for the patient, the support regions 20, 21, 22, 23 are provided with the adhesively bonded support bodies 30, 31, 32, 33 of integral foam. The support bodies 30, 31, 32, 33 have projections 303, 313, 323, 333 at their ends in the transverse direction Q of the main body, which projections are oriented away from the placement regions 10, 11, 12, 13, 14 of the main body and prevent the foot or lower leg of a patient from slipping laterally. Furthermore, the support bodies 30, 31, 32, 33 define a radius R1 of 1.5 m in the transverse direction Q of the main body between the projections 303, 313, 323, 333 (and thus on their side oriented away from the placement regions 10, 11, 12, 13, 14 of the main body in the mounted state of the support bodies).

The support bodies 30, 31, 32, 33 are described in greater detail below with reference to FIGS.

5a to 5c using the example of the support body 33: The support bodies 30, 31, 32, 33 each have a flat surface 301, 311, 321, 331 on one side, which surface encloses an angle γ of 45° shown in FIG. 3 with a plane defined by the placement regions 10, 11, 12, 13, 14 in the mounted state of the support bodies 30, 31, 32, 33, and have a cylindrical surface 332 on a side facing away from the flat surface. In the region of the cylindrical surface 332, the support bodies have air ducts (not shown in the figures) extending in their interior in the transverse direction of the leg supporting aid. In the mounted state, the flat surface 301, 311, 321, 331 of the support bodies 30, 31, 32, 33 is oriented toward support regions 20, 21, 22, 23 which have a smaller height than that support region 20, 21, 22, 23 on which the respective support body 30, 31, 32, 33 is mounted.

The plan view shown in FIG. 2 shows the pattern of a ladder whose outermost rungs are formed by the placement regions 10 and 14 and whose inner rungs are formed by the support regions 20, 21, 22, 23. The beams of this ladder are formed jointly by sections of the placement regions 11, 12 and 13 and by sections of the support regions 20, 21, 22, 23.

Elongated holes 40, 41, 42 and 43 are respectively formed in the placement regions 11 and 13 of both beams, through which a fastening strap (shown only in FIGS. 6a to 6f) can be threaded. By means of this fastening strap, the leg supporting aid can be flexibly fastened to an operating table or to a leg support of an operating table.

In the present embodiments, the main body of the above-described leg supporting aid was produced by 3D printing on a 3D printer “LC Magna v. 2” using light-curing resin sold under the designation “Magna Hard”. Both the 3D printer “LC Magna v. 2” and the light-curing resin “Magna Hard” can be purchased from Photocentric Ltd (3D), Titan House, 20 Titan Drive, Peterborough, PE1 5XN, United Kingdom of Great Britain and Northern Ireland. Subsequently, the main body was provided with a surface coating in the form of a lacquer in order to increase the surface quality.

Alternatively, the main body of the above-described leg supporting aid can be formed by injection molding the main body and adhesive bonding the support bodies 30, 31, 32, 33 to the regions of the support regions 20, 21, 22, 23 of the main body which face away from the adjacent placement regions 10, 11, 12, 13, 14, 15. In such a case, it is often not necessary to increase the surface quality of the main body by a coating.

Furthermore alternatively, it is e.g. also possible, to manufacture the main body by plastic deformation of a plate-shaped material (in particular thermoplastic, i.e. plastomer material) by means of a press and then to attach the support bodies. Also in this case, it is normally not necessary to increase the surface quality of the main body by a coating.

In order to be able to adapt the leg supporting aid well to different patient groups (e.g. children or patients of small stature) (in particular with regard to the distance between the support regions and the heights of the support regions), production of the main body by 3D printing is advantageous.

In the embodiment shown, the same support bodies were used for all support regions. Alternatively, however, it is also possible to use differently shaped support bodies for different support regions.

A leg supporting aid comprises a main body having a longitudinal direction (L) and a transverse direction (Q) in plan view. The longitudinal direction has a greater extent than the transverse direction. The main body has at least three placement regions (10, 11, 12, 13, 14) and at least two support regions (20, 21, 22, 23). In the longitudinal direction of the main body each of the support regions is respectively located between two placement regions connected to one another via the respective support region. The placement regions are coplanar. The support regions have different heights relative to the adjacent placement regions. Furthermore, the placement regions and support regions are manufactured in one piece and thus constitute the main body.

What is claimed is:

1. A leg supporting aid, comprising:
a main body which has a longitudinal direction and a transverse direction in plain view, wherein the longitudinal direction has a greater extent than the transverse direction,
wherein the main body has at least three placement regions and at least two support regions along its longitudinal direction,
wherein in the longitudinal direction of the main body each of the at least two support regions respectively is located between two adjacent placement regions connected to one another via the respective support region,
wherein the placement regions are coplanar,
wherein the support regions have different heights relative to the adjacent placement regions and wherein the placement regions and support regions are manufactured in one piece and thus constitute the main body.

2. The leg supporting aid according to claim 1, wherein the material thickness of the main body in the placement regions deviates from the material thickness of the main body in the support regions by less than 20% and preferably by less than 10% and more preferably by less than 5%.

3. The leg supporting aid according to claim 1, wherein the support regions have U-shaped or V-shaped cross-sections in the longitudinal direction of the main body, wherein the free ends of the legs of the “U” or “V” of each support region merge into the placement regions adjacent to the support region.

4. The leg supporting aid according to claim 3, wherein the support regions have a support body at the junction of the legs of the “U” or “V”, the material of which support body differs from the material of the main body.

5. The leg supporting aid according to claim 4,
wherein the main body consists of hard plastics material and in particular of injection-moulded polycarbonate or polyester or light-curing resin.

6. The leg supporting aid according to claim 4,
wherein the support bodies are non-detachably connected to the respectively associated support region by injection-molding or adhesive bonding or a snap-on connection, or
wherein the support bodies are detachably connected to the respectively associated support region by a screw connection or snap-on connection.

7. The leg supporting aid according to claim 4, wherein the support bodies extend in a straight line in the transverse direction of the main body and have projections at their ends in the transverse direction of the main body, which projections are oriented away from the placement regions of the main body.

8. The leg supporting aid according to claim 4, wherein the support bodies have a flat surface on a side which faces support regions having a smaller height than the support region on which the respective support body mounted, and have a rounded and in particular cylindrical surface on a side facing away from the flat surface.

9. The leg supporting aid according to claim 4, wherein the support bodies each have a surface on their sides facing away from the placement regions, which surface defines a radius of curvature of between 1 m and 2 m and in particular of 1.5 m in the transverse direction of the leg supporting aid.

10. The leg supporting aid according to claim 4, wherein the support bodies have weakenings on a side which faces away from support regions having a smaller height than the support region, and in particular air ducts extending through the support bodies in the transverse direction of the leg supporting aid.

11. The leg supporting aid according to claim 1,
wherein the main body has the shape of a ladder in plain view,
wherein rungs of the ladder with the exception of the lowermost and uppermost rungs are formed by the support regions
wherein the lowermost and uppermost rungs are formed by placement regions,
wherein beams of the ladder are formed jointly by sections of the placement regions and the support regions, and
wherein the beams of the ladder do not project beyond the lowermost and uppermost rungs.

12. The leg supporting aid according to claim 1, wherein elongated holes for receiving a fastening strap are formed in placement regions that are spaced apart from one another by at least one support region.

13. The leg supporting aid according to claim 1, wherein the support regions have a greater extent in a direction which is perpendicular to a plane defined by the placement regions in relation to this plane than the placement regions.

14. The leg supporting aid according to claim 1, wherein at least the lowest support region relative to the adjacent placement regions has a recess as seen in the longitudinal direction of the main body, which recess is limited in the height direction by the support body associated with the support region.

15. The leg supporting aid according to claim 14, wherein the recess has a free cross-section as seen in the longitudinal direction of the main body, which is able to accommodate a rectangle with a width of more than 8 cm and in particular of between 9 cm and 11 cm and further in particular of 10 cm and a height of between 2 cm and 5 cm and in particular of 4 cm.

16. A method for producing a leg supporting aid according to claim 1, comprising the following steps:
providing a main body by injection molding, plastic deformation or 3D printing, wherein the main body has a longitudinal direction and a transverse direction in plain view, wherein the longitudinal direction has a greater extent than the transverse direction, and wherein the main body has at least three placement regions and at least two support regions along the longitudinal direction, wherein the support regions are respectively located between two placement regions connected to one another via the respective support region, wherein the placement regions are coplanar, wherein the support regions have different heights relative to the adjacent placement regions and wherein the placement regions and support regions are manufactured in one piece and thus constitute the main body; and
attaching support bodies to the regions of the support regions which face away from the adjacent placement regions, wherein the support bodies are formed from a material different from the main body.

17. The leg supporting aid according to claim 1, wherein in the longitudinal direction and the transverse direction of the main body the material thickness of the main body in a direction which is perpendicular to a plane defined by the placement regions varies by less than 10% and more preferably by less than 5% and is in particular constant.

18. The leg supporting aid according to claim 1, wherein in the longitudinal direction and transverse direction of the main body the material thickness of the main body in a direction which is perpendicular to a plane defined by the placement regions in the support regions amounts to between one and seven times or between one and five times the material thickness of the main body in the placement regions.

19. The leg supporting aid according to claim 1, wherein the main body has at least four placement regions and at least three support regions or wherein the main body has at least five placement regions and at least four support regions or wherein the main body has at least six placement regions and at least five support regions.

20. The leg supporting aid according to claim 1, wherein a height of the support regions relative to the adjacent placement regions is between 1.5 cm and 20 cm and in particular between 2 cm and 15 cm.

21. The leg supporting aid according to claim 1, wherein a material thickness of the main body is between 4 mm and 15 mm and in particular between 8 mm and 12 mm and more particularly 10 mm.

22. The leg supporting aid according to claim 1, wherein the support regions are arranged in the longitudinal direction of the main body such that their height relative to the adjacent placement regions increases from one end of the main body to the other end of the main body.

23. The leg supporting aid according to claim 1, wherein the main body has five placement regions and four support regions, wherein the height of the support regions relative to the adjacent placement regions is 4.1 cm, 6.7 cm, 9.2 cm and 13.4 cm, and wherein perpendicular bisectors of adjacent support regions are each spaced apart by 15 cm.

24. The leg supporting aid according to claim 4, wherein the support bodies consist of foam material and in particular of polyurethane or ethylene-propylene-diene rubber.
